(19) United States
(12) Patent Application Publication
(10) Pub. No.: US 2009/0151578 A1
(43) Pub. Date: Jun. 18, 2009

(54) METHOD OF AND APPARATUS FOR MOUNTING PRINT SCREENS AND THEIR USE IN PRINTERS, AS WELL AS A SCREEN FRAME AND A SCREEN-PRINTING MACHINE

(76) Inventors: Josef Kleinschnitz, Greussenheim (DE); Peter Schmitt, Wuerzburg (DE)

Correspondence Address: K.F. ROSS P.C., 5683 RIVERDALE AVENUE, SUITE 203 BOX 900, BRONX, NY, 10471-0900, US

(21) Appl. No.: 12/331,624

(22) Filed: Dec. 10, 2008

(30) Foreign Application Priority Data
Dec. 14, 2007 (DE) 102007060917.7

(51) Int. Cl. B41C 1/14

(52) U.S. Cl. 101/128.4

(57) ABSTRACT

A screen-printing process uses screens each having a frame in which is tensioned a respective mesh. Each of the meshes is tensioned and data representing tensions in the respective meshes is stored in respective memories carried on the frames of the meshes. Subsequently one of the meshes is secured in a holder of a screen-printing machine and the data from the memory of the mesh in the holder is read out. Thereafter tensions in the screens are monitored and, when the monitored tensions differ significantly from the data read out of the respective memory, tensions in the screen are reset.

The invention relates to a method for making print screens for and using printing screens in a screen-printing machine, especially in flat screen printing as well as to an apparatus for producing or operating printing screens. The invention furthermore relates to a screen frame as well as to a screen-printing machine.

The mono- or multi-color printing of very different products such as cans, bottles, tubes, CDs or DVDs, electronic articles, article of clothing such as T-shirts or caps or general printed materials by screen-printing methods has been customary for many years. In most instances screen-printing mechanisms are used for this that operate with a flat screen. In order to produce the flat screen the mesh is stretched within a stable frame under a mechanical pretensioning and fixed on the frame.

In order that the printing screen obtained in this manner can be used in a printing machine, the image to be printed must be imparted to the mesh to create image-forming zones in the mesh where the mesh is permeable to printing ink and image-free zones where the mesh is impermeable to printing ink.

Therefore, in order to create an image on the screen, the stretched printing mesh is first coated with a photo-structurable lacquer that initially renders the printing screen impermeable to printing ink.

In another embodiment an already coated fabric is stretched on the printing frame. In a subsequent step the coated fabric is illuminated with an imager, for example, an imager with the motif to be printed, as a result of which, depending on the type of photolacquer used on the mesh, either a polymerization of the illuminated lacquer takes place and it becomes insoluble, or a depolymerization of the illuminated portions takes place and the lacquer becomes soluble at these sites. In a subsequent development step the soluble zones of the photolacquer are removed from the screen so that the screen is permeable to printing ink only at the desired sites.

In an alternative imager appropriate lacquers or waxes can be applied onto the mesh with by inkjet printing in such a manner that image-free zones are produced that are impermeable to printing ink.

It is therefore necessary to prepare a separate printing screen for each motif to be printed and each color to be printed and to provide an appropriate number of replacement printing screens in order to ensure a smooth printing operation, as a result of which an expensive stocking of printing screens is necessary, in particular in the case of a rather large number of printing motifs.

The described manner of production and use of printing screens and in particular of their stocking has the disadvantage that the mechanical tensioning of the printing screens that was imparted to them after imaging, whether by inkjet printing and/or illumination and development of the screens, can be changed.

On the one hand the mechanical cohesion of the mesh filaments can be changed on account of the lack of photolacquer in the image-carrying zones and other mechanical conditions can prevail as a result of which at least locally different screen tensions can be produced. On the other hand the screen tension can also be locally adversely affected by the illumination and development procedure in that the mechanical properties of the mesh fibers are influenced by the light, especially by UV light and/or the chemical influence of the development liquids, so that the actual screen tension deviates more or less from the initially set screen tension. Likewise, screen tension can change on installation of the imaged printing screens.

The quality of a printed image can be directly influenced by a change of the screen tension, which can, in addition, be different in different zones of a printing screen, as a result of which quality changes can result, especially when replacing a printing screen due to a screen tear, so that a new adjustment of the optimal required contact pressure of the doctor blade must take place at every screen replacement.

The object of the invention is therefore to eliminate the cited disadvantages and create an apparatus and a method with which a screen frame can be given a predetermined mechanical pretensioning, can be imaged and optionally subsequently retensioned, during which a checking of the tensioning and the determination of screen errors should be made possible.

The problem is solved by a method in accordance with the invention in which a screen frame that is provided with a mesh or will be provided with one in a following step is secured and positioned in a holder and its position and orientation are determined. The screen is then mechanically tensioned and the forces exerted are determined, during which at least the determined forces are stored as force data in a memory attached to the screen frame. A screen frame tensioned in this manner can then be removed from the apparatus and used.

For example, a mesh for making the printing screen from a supply roll onto a screen frame provided for this purpose can be tensioned. This tensioning can take place prior to the insertion into the apparatus of the invention or subsequently. Thus, for example, a screen frame can be inserted at first into a holder of a tensioning apparatus provided for this purpose, fixed in it and, for example, piece of a stored mesh can be tensioned on the screen frame in that, for example the mesh is clamped between an upper and lower frame part of the screen frame, in particular, therefore, in a frame that is divided into two parts relative to its frame thickness.

The given mechanical tensioning as well as optionally further geometric reference data is stored on the screen frame in a respective rewritable, suitable memory so that it can be read out in a printing machine with suitable means in a holder adapted to the screen frame. The holder inside the printing machine can comprise tensioners with which the screen frame and the mesh stretched in it can be retensioned and the mechanical tensioning of the mesh can be set therewith to the predetermined and stored tensioning values and/or can be selectively changed if necessary.

A screen frame in accordance with the invention that can be used here can comprise several side parts or frame elements that are connected to each other via shiftable connection elements and comprise at least one memory in which data at least about the forces is stored or can be stored with which a mesh can be tensioned or is tensioned in the screen frame. The size of the frame can be changed by the shiftable connection elements and thus also the tensioning of the mesh present in it.

The frame parts of the screen frame can have an appropriately roughened and/or structured, e.g. toothed surface, in accordance with the invention, for example toward the mesh, so that the stretched mesh can be securely held fast.

In order to make it possible to shift, the corner connections of the frame elements are designed for example in such a manner in accordance with the invention that they can slide on each other and with respect to each of the frame elements connecting them and can be fixed to each other by additional suitable clamps so that the frame elements can be shifted against each other by means of a tensioner attacking from the outside and the mesh can be tensioned therewith.

At the same time the holder can comprise according to the invention at least one stationary reference point and/or can be provided with sensors, as a result of which the location and position of the screen frame can be determined. To this end the screen frame also comprises in accordance with the invention, for example, a reference point so that, for example, the intervals of the reference points of the holder and of the screen frame and as a result the actual location and position of the screen frame and of the tensioner to each other can be detected by the cited sensors and can be passed on to a higher-order controller, as a result of which an unambiguous and reproducible and/or an adapted positioning of the printed image in the screen frame can be made possible.

It can furthermore be provided in accordance with the invention that the tensioner comprises further sensors for determining the screen tension and that their detected data can be passed on to a higher-order controller, as a result of which it is possible to adjust a desired screen tension. It can be advantageous to fix a screen frame pretensioned to a certain screen tension with clamps attached to the screen frame so that no change of the screen tension, in particular no inadmissible relaxation of the mesh and of the screen frame, can take place even after removal of the screen frame from the holder.

It can furthermore be provided according to the invention that the detected positional data and/or location data of the screen frame and/or the determined screen tension data is stored, in particular by a suitable writing device, for example, is stored in a memory attached to the screen frame and thus remains on the particular screen frame.

As a result, it is possible in accordance with the invention to store an individual data set on each screen frame and therewith each printing screen before and/or after a particular imaging of the mesh, which data set can be read out in accordance with the invention, for example, in an appropriately designed holder for the printing screen or screen frame with mesh in a printing machine, e.g. with a suitable reader and therefore, for example, an alignment and/or a retensioning of the mesh can take place, e.g. as a result of the fact that the stored data is compared with the current data and in the case of deviations a new set of values is stored.

The invention can furthermore provide that the printing pattern can be transferred in a subsequent step onto the stretched mesh provided with a mechanical pretensioning in that, for example, an uncoated mesh is provided with a structurable coating, for example, with a photolacquer. The application can take place by a spray apparatus or a coating method or a dip method.

An optionally following drying or fixing of the photolacquer hardens the coating at least to the extent that imaging taking place in a subsequent step can take place optically without problems by photomasks or a laser illumination. Depending on the positively or negatively acting photolacquer, either the image-free zones are insolubly hardened during irradiation or the image-carrying zones are entirely or at least partially depolymerized. To this end, for example, during the use of a UV-sensitive photolacquer those zones of the screen are irradiated with UV light by a UV light source over a printing pattern that are necessary for the printing. Depending on the lacquer used, this can be either the image-carrying zones or the image-free zones. Subsequent development fixes the photolacquer and/or removes the photolacquer on the imaging positions so that they become permeable to a printing ink.

It is also possible to use a precoated mesh instead of an uncoated mesh, so that the cited coating becomes superfluous.

The printing screen prepared in this manner is therefore ready for being used in an associated printing mechanism of an appropriate printing machine and can be removed from the holder.

An optionally occurring mechanical relaxation of the printing screen can be provided here and can be held in limits, for example, at least partially in that the mechanical design of the screen frame is selected in such a manner that on the one hand a mechanical retensioning of the mesh stretched in the screen frame can take place by an external tensioner and/or on the other hand a relaxation of the stretched screen can be kept slight by an appropriate design of the screen frame.

As an alternative to the above, imaging can also take place, for example with an inkjet printing method in that an appropriate printing ink is applied to the uncoated screen exclusively for producing the image-free zones and fixed there, in contrast to which the image-carrying zones remain free. A subsequent optionally required hardening of the printing ink fixes the printing ink permanently on the mesh and makes possible use in a screen-printing machine.

A printing screen (screen frame with mesh) produced in this manner and provided with individual data can subsequently be placed in accordance with the invention in a holder of a printing machine provided for this purpose, which holder can comprise additional devices for securing the printing screen. According to the invention the holder can furthermore comprise a device for reading out the data stored in the memory of the screen frame, during which the read-out data can be transmitted for further processing, for example, into a higher-order control of the printing machine.

Thus, it can be provided in accordance with the method of the invention that a screen frame provided with a mesh is fastened in a holder, that at least force data is read out of a memory arranged on the screen frame that represent the forces with which the mesh was originally tensioned in the screen frame, that the screen frame is positioned and that the forces currently tensioning the mesh in the screen frame are detected.

The mesh can be retensioned in case of a deviation of the currently measured forces from the original forces, especially in case of deviation exceeding a tolerance.

The use of actuators optionally provided in accordance with the invention and/or of positioners for the printing screen and/or the holder makes it possible by an evaluation of the transmitted data to position, for example, the screen frame and/or the holder using stationary reference points fixed, for example, in the printing machine and using the position and location data stored in the screen-printing frame to position the screen-printing frame and therewith the printing pattern into a desired position and alignment.

It is also possible in accordance with the invention to measure and/or adjust as desired the initial and the instantaneous screen tension of the mesh, for example, to a screen tension value stored in the memory of the screen frame and used during the imaging of the printing screen by means of appropriate traction- and/or pressure units provided for this purpose and exerting forces on the side elements of the screen-printing frame and by means of appropriate force sensors integrated into the particular directions of force of the traction- or pressure units.

This also makes it possible in accordance with the invention to readjust the screen tension in accordance with a desired value in order to compensate in this manner, for example, for a relaxing of the screen tension on account of the mechanical load during a continuous printing operation, so that a desired screen tension can be constantly maintained.

According to the invention the holder for the printing screen (screen frame with mesh) in the printing machine corresponds at least substantially to the holder for the printing screen in the manufacturing apparatus. Tensioners for the mesh stretched in the screen frame are also present as well as aligning devices for the screen frame relative to reference points related to the machine.

According to the invention the data stored in the screen frame in its respective memory regarding the screen tension adjusted during the manufacture and regarding the corresponding reference positions can be read out to this end. The screen tension is subsequently produced via the tensioners by means of a controller and the positioning of the printing screen is carried out. To this end appropriate sensor apparatuses for measuring the mechanical screen tension and for measuring the position of the screen frame can be provided, as a result of which it is also possible to selectively or automatically vary or maintain constant, for example, the screen tension.

It can also be possible according to the invention to recognize a screen tear early by means of the screen tension detectable via the sensors given an appropriate design of the sensors and an appropriate processing of the measured data determined in this manner in that, for example, a certain number of force sensors are arranged in pairs and symmetrically, especially opposite one another around the screen frame, in such a manner that during a normal operation their measured values balance in the pairs. An asymmetry of the measured values that occurs already upon a beginning screen tear can then be evaluated as an indicator for a screen tear.

An embodiment of the invention is shown in the following figures.

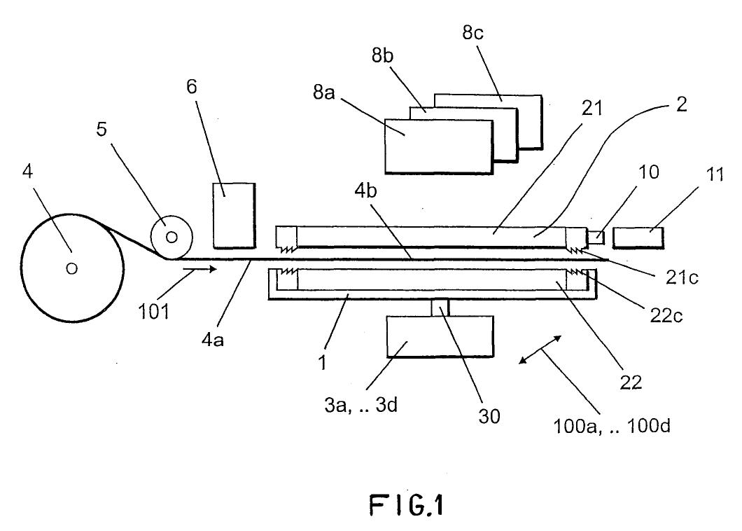

FIG. 1 is a schematic view of an imager in accordance with the invention.

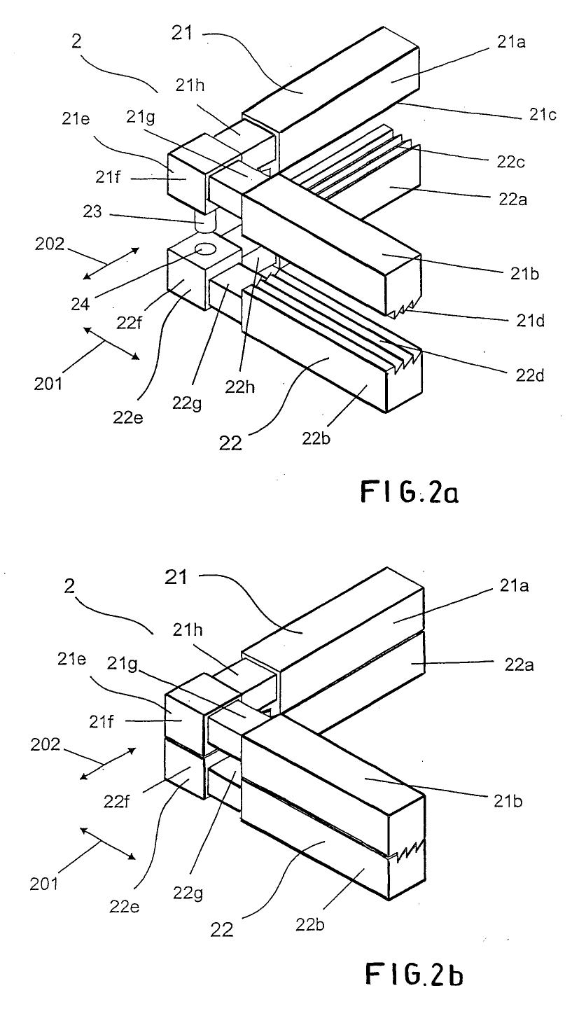

FIG. 2a is a detail view of a screen frame in accordance with the invention in a first, open position.

FIG. 2b is a detail view of a screen frame in accordance with the invention in a second, closed position.

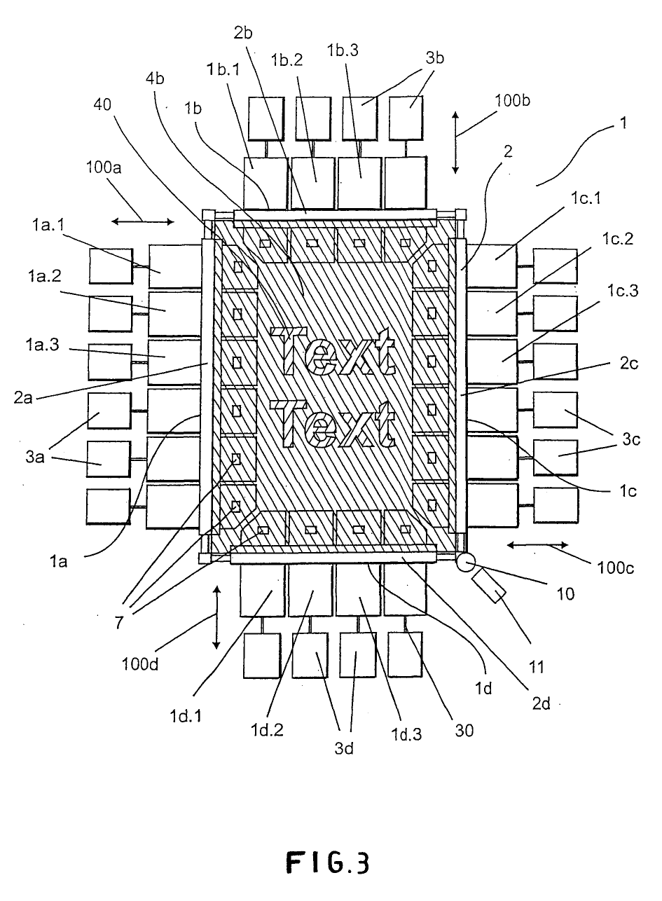

FIG. 3 is a schematic view of a holder in accordance with the invention for screen frames with read/write devices.

FIG. 1 shows a schematic view of an apparatus in accordance with the invention for producing and imaging screen-printing screens. The apparatus comprises a holder 1 for holding a screen frame 2 that comprises, for example, of an upper part 21 and a lower part 22 that can fit together, e.g. via complementary pins 23 and holes 24.

In order to produce a printing screen, according to the invention a piece 4b of a mesh 4a, e.g. from a mesh-supply roll is inserted in a first step via guides 5 in a direction 101, for example, by means of a conveyor (not shown) in such a manner between the upper part 21 and the lower part 22 of the screen frame 2 that when the two parts 21 and 22 are joined together, which takes place in a second step, the mesh can be firmly stretched between the sides of the screen frame.

In addition, the frame elements 21 and 22 can be fixed together in a joined position, for example, by clamps or screws (not shown). A cutter 6 provided by way of example subdivides the mesh 4a subsequently between the screen frame 2 and the supply roll 4 so that only the predetermined piece 4b of mesh 4a comes to rest in frame 2.

The mesh 4b stretched and fixed in the screen frame 2 can be pretensioned in a third step to a desired mechanical tensioning by tensioners 3a, . . . 3d attached to the sides of holding frame 1 and acting in respective directions 100a, . . . 100d, so that the screen frame is ready for coating and/or imaging. Imaging of the mesh 4b stretched in this manner can take place in a subsequent fourth step, for example, in that first an appropriate coating that can be structured, for example with optical means, is applied with a coating device 8a to the mesh 4b in such a manner that, for example, a closed surface can be produced.

An imager 8b operating for example optically transfers a printing pattern in a fifth step to the previously applied coating, as a result of which, for example, oi hardens at the illuminated regions and therefore becomes insoluble. When using an oppositely operating coating the coating applied in the cited fourth step is hardened immediately afterward by an apparatus (not shown) and subsequently imaged in the cited fifth step. The imaging takes place in this instance in that the hardened coating is removed on the ink-transferring zones, for example, by laser irradiation, so that these zones of the printing screen become permeable to printing ink.

In a following sixth step the printing screen imaged in this manner can be removed, for example, by a developer and/or washer 8c from undesired remnants of the coating, so that the printing screen can subsequently be used in a printing machine. At the same time or immediately prior to removal of the printing screen frame 2 from the holder 1 the invention provides that the forces exerted on the particular sides of the screen frame and therewith the tensions in the screen are detected by sensors 7 and transmitted by a writing device 11 into a memory 10 mounted for this purpose on the screen frame.

It can furthermore be provided in accordance with the invention that positional data and location data of the printing screen 2 determined simultaneously via appropriate sensors and relative to fixed reference points are transmitted via the writing device 11 into the memory 10. The memory 10 can be a memory that operates magnetically or optically or, however, a non-volatile semiconductor memory to which the data can be transmitted, for example, via appropriate electrical connections or by a magnetic, optical or RFID read/write method and/or can be erased and/or stored data can be read out.

In order to ensure good holding of the mesh 4b in the screen frame 2 and in order to allow movement of the two parts 21 and 22 relative to one another when joined together, the invention can provide as schematically shown in FIGS. 2a and 2b that the confronting faces 21c and 22c of frame elements 21a, 22a, 21b, 22b of the upper part 21 and of the lower part 22 facing the mesh 4b are complementary structured, for example, in that shaped such as pyramids, sawtooth structures or even needle-like pins and complementary seats therefore are provided in the confronting faces 21c, 22c, 21d, 22d.

As a result, on the one hand the mesh 4b can be effectively held fast in the joined position of the frame parts 21 and 22 between them and on the other hand the position of the two frame parts 21 and 22 to one another can be unambiguously determined.

The invention can furthermore provide that the frame elements 21a, 21b and the frame elements 22a, 22b are connected to each other at their ends in such a manner via connection elements 21e and 22e, especially a corner connection elements, that the frame elements 21a, 21b and 22a, 22b can be shifted longitudinally relative each other in directions 201 and 202.

To this end, the frame elements 21a, 21b and 22a, 22b are tubular, for example, at least at their ends. The connection elements 21e, 22e comprise, for example, a rectangular corner element 21f to which two arms 21g, 21h and 22g, 22h attached at a right angle to each other engage into the tubular ends of the frame elements 21a, 21b and 22a, 22b and are supported therein in such a manner that they can shift along the axis of the respective frame elements. This makes it possible to change the size of the frame within certain limits and/or to tension a printing screen stretched between the lower and the upper frame 21 and 22 with external means. The corner elements 21e, 22e can comprise additional connection elements such as, for example, the pins 23 and the complementary bores 24 that engage into each other on joining of the upper frame part 21 to the lower frame part 22.

The invention can furthermore provide that the frame parts 21 and 22 can be connected to one another by fasteners (not shown).

FIG. 3 schematically shows an embodiment of an apparatus in accordance with the invention for holding and tensioning a printing screen provided with a mesh such as can be used, for example, in a printing machine. To this end the screen frame 2 is inserted in such a manner into a holder 1 provided to this end that its sides 2a, 2b, 2c, 2d can be firmly connected to the grippers 1a.1, 1a.2, 1a.3, . . . , 1b.1, 1b.2, 1b.3, . . . , 1c.1, 1c.2, 1c.3, . . . , 1d.1, 1d.2, 1d.3, . . . of the sides 1a, 1b, 1c of the holder 1 by means of fasteners (not shown). The printing screen 2 is already prepared here for being used in a printing method and comprises a the mesh 4b imaged with a print image 40.

In order to adjust screen tension for an optimal operating method and therewith for an optimal printing result, which tensioning additionally corresponds substantially to the screen tension during manufacture of the printing screen, the invention provides that the data of files in the memory 10 of the printing screen 2 such as, for example, screen tension data and/or position data is read out in a first step by a suitable reader 11 and transmitted to a higher-order controller (not shown). Using this data set, it is possible according to the invention in a second step to align the screen frame 2 in its holder 1, for example, relative to stationary reference points in order, for example, to align a printing pattern 40 written into the mesh 4b on a printing substrate in this manner.

It is furthermore possible in accordance with the invention to tension the mesh with the side elements 2a, 2b, 2c, 2d of the screen frame 2 by means of the respective side elements 1a, 1b, 1c, 1d of the holder 1. To this end the side elements 1a, 1b, 1c, 1d of the holder 1 are subdivided in accordance with the invention, for example, into several sections/segments 1a.1, 1a.2, 1a.3, . . . , 1b.1, 1b.2, 1b.3, . . . , 1c.1, 1c.2, 1c.3, . . . , 1d.1, 1d.2, 1d.3, . . . that connected to respective push-pull actuators 3a, 3b, 3c, 3d that can be independently controlled so that it is possible, given an appropriate control of actuators 3a, 3b, 3c, 3d, to shift the screen frame 2, for example, in directions 100a, 100b, 100c, 100d and thereby tension the particular side parts 2a, 2c and 2b, 2d against each other along the respective directions 100a, 100c and 100b, 100d.

It is furthermore possible by the subdivision, further provided in accordance with the invention, of the particular sides 1a, 1b, 1c, 1d of holder 1 into several sections/segments 1a.1, 1a.2, 1a.3, . . . , 1b.1, 1b.2, 1b.3, . . . , 1c.1, 1c.2, 1c.3, . . . , 1d.1, 1d.2, 1d.3, . . . to tension the mesh 4b differently at least in zones depending on requirements and that, for example, opposing segments 1a.1 and 1c.1, 1a.2 and 1c.2, etc. exert different forces on the respective zones of the mesh 4b stretched between them, so that, for example, a zone-by-zone relaxing of a desired screen tension can be compensated on the basis of the mechanical load occurring during operation.

The invention can furthermore provide for this purpose that each of the sections/segments 1a.1, 1a.2, 1a.3, . . . , 1b.1, 1b.2, 1b.3, . . . , 1c.1, 1c.2, 1c.3, . . . , 1d.1, 1d.2, 1d.3, . . . has a respective sensor 7 for measuring the respective tensions and for measuring the particular occurring forces. The data detected in this manner can be detected, for example, by a higher-order control (not shown), that controls the particular tensioners 3a, 3b, 3c, 3d of the segments 1a.1, 1a.2, 1a.3, . . . , 1b.1, 1b.2, 1b.3, . . . , 1c.1, 1c.2, 1c.3, . . . , 1d.1, 1d.2, 1d.3, . . . in accordance with a corresponding desired processing.

It can be advantageous here to use an apparatus that is substantially the same as the apparatus described in accordance with FIG. 3 in the production of the printing screen 2 so that, for example, the tensions used in the production of the printing screen 2 and/or positional data can be readily reproduced in the printing machine in that this data is detected in a similar manner during the production and is written into the memory 10 and subsequently read out in the printing machine and processed.

The apparatus for producing the printing screen can therefore have the same sensors and actuators as the apparatus for holding the printing screen in a printing machine.

It can be determined regarding all embodiments that the technical features cited in conjunction with one embodiment can be used not only with that specific embodiment but rather also in the other embodiments. All disclosed technical features of this description of the invention are to be classified as essential for the invention and can be combined as desired with each other or used by themselves.

1. A method of making screens for use in a screen-printing machine, characterized by the following steps:
a) a screen frame that is or will be provided with a screen is secured and positioned in a holder and its position and orientation are determined;
b) the mesh is mechanically tensioned and the applied tension is detected;
c) at least the detected tensions are outputted to a memory provided on the screen frame;
d) the screen frame is taken out of the holder.

2. The method according to claim 1 wherein a piece of mesh is taken off a supply roll and secured on/in the screen frame, in particular by clamping between a lower part and an upper part of the frame.

3. A method of operating a screen-printing machine with print screens, characterized by the following steps:
a) a screen frame provided with a mesh is secured in a holder;
b) force data is read from a memory on the screen frame that represent the forces with which the screen in the frame was originally tensioned;
c) the screen frame is positioned and the current tension forces of the mesh in the screen frame are detected;
d) if a deviation between the current tension forces and the original forces is detected, the mesh is retensioned.

4. The method according to claim 3 wherein the memory on the frame can be written to or erased or read magnetically, optically or by an r-f signal by a read or write device on the holder.

5. The method according to claim 3 wherein the tensions are applied to respective frame elements of the frame by respective independently controllable actuators or detected by respective sensors on the frame elements.

6. The method according to claim 3 wherein tensions in the mesh are detected by opposing sensors on the holder of the frame and a mesh problem such as a tear is determined when tensions are unbalanced.

7. The method according claim 3 wherein the memory evaluates data for positioning or orienting the frame or the mesh for operating the print screen in a printing machine and the screen frame or the mesh are tensioned at the stored values.

8. The method according to claim 3 wherein the mesh is imaged optically by irradiation or a laser irradiator or by means of an inkjet printer.

9. An apparatus for making or using screen-printing screens wherein it has a holder in which a screen frame is positionable, the position and orientation are detected and a mesh is mechanically secured in or on the frame and that forces applied by the holder to tension the mesh are detectable, and the holder has a read or write device, and that data indicating the position or orientation or applied forces can pass in at least one direction between the read or write device and a memory on the frame.

10. The apparatus according to claim 9 wherein the holder has on each side at least two segments moveable relative to each other independently in at least one direction.

11. The apparatus according to claim 10 wherein the segments have respective independently controllable tensioners or respective sensors for determining the respective traction forces or the respective screen tensions.

12. The apparatus according to claim 9 wherein the write or read device can read or write or erase the memory of a screen magnetically, optically, or by an r-f signal.

13. The apparatus according to claim 9 wherein the holder is adjustable in accordance with data read from the memory of a screen frame for positioning the print screen and setting the tension of a mesh on the frame.

14. The apparatus according to claim 9 wherein the holder has a coating device or an imaging device or a developing device a mesh tensioned in a frame.

15. The apparatus according to claim 9 wherein the apparatus is a screen-printing machine.

16. A screen-printing frame characterized in that it has a plurality of side parts that are connected together by slidable connector elements and have at least one memory in which data relating to tension in or to be applied to a mesh is or can be stored.

17. The screen-printing frame according to claim 16 wherein the side parts can be fixed relative to one another.

18. The screen-printing frame according to claim 16 wherein it has an upper part and a lower part between which a mesh can be secured.

19. The screen-printing frame according to claim 16 to 18 wherein faces of the upper and lower parts turned toward the mesh have complementarily structured surfaces.

20. A screen printing machine with a holder for screen-printing frames wherein the holder has a reader for reading from a memory on a screen frame data and means for positioning the screen frame and for mechanically tensioning a mesh in the screen frame, in particular depending on the read data.
